(19) United States
(12) Patent Application Publication
(10) Pub. No.: US 2008/0039070 A1
(43) Pub. Date: Feb. 14, 2008

(54) Remote mobile testing probe

(76) Inventor: Amnon Ptashek, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/479,799

(22) Filed: Jun. 29, 2006

(51) Int. Cl. H04Q 7/20

(52) U.S. Cl. 455/423

(57) ABSTRACT

A system for testing communications between an application executed on a mobile terminal and a server seated on a remote network includes a probe concentrator for receiving a communication from the mobile terminal and transmitting the communication to a remote probe, the remote probe configured to transmit the communication to a remote server via a remote network, and receive a responsive communication from the remote server, and transmit it to the probe concentrator which transmits it further to the mobile terminal. The probe concentrator may include an analysis block to analyze captured data and generate analysis results therefrom.

### BACKGROUND

1. Field of the Invention

The present invention relates to remote testing of mobile communication devices, and more particularly, to a system that enables the testing of applications executing on a locally sited mobile communication device with remote servers on remotely sited communication networks.

2. Related Art

Cellular networks over the globe offer similar consumer services, but often operate according to a variety of different architectures and communication protocols. CDMA and GSM networks exemplify two fundamentally different types of cellular systems that are widely used in many countries, including the United States. While system architectures differ at a high level, various installations of a particular type of system may further introduce lower level inconsistencies due to unique, inherent characteristics of the implementation at a geographic location, for example. Otherwise like systems from one geographic region to the next therefore sometimes operate subject to small, but substantial, differences.

Operational differences such as these pose particular difficulties with respect to testing devices designed to use the many cell networks available. When cellular device developers add new, advanced applications to their products, they typically must first seek certification by the service providers to ensure proper operation on the providers' systems. Challenges arise as to testing new device applications because successful operation in the environment of one cellular system does not necessarily guarantee successful operation in another, geographically removed environment. For example, a mobile phone developer may develop an application requiring media transport. If the application is to maximize market reach, it must be deployed globally, and must therefore be tested on handsets configured for each of many different cellular network environments. Thorough testing becomes cumbersome and expensive because the various networks are distributed on a global basis. In the extreme, mere physical access to a geographically remote network for testing may become a fundamental problem.

Conventional solutions to the problem of testing a mobile handset or mobile terminal application under the conditions of a geographically remote cell network are few. One way is simply to simulate or replicate the network locally. Testing may then proceed within the confines of the developer's premises, for example. However, a simulation or replication often does not comprehend subtle characteristics of the actual, deployed remote cellular network, leading to compatibility issues later when consumers attempt to make use of the application over a particular network. Another way is for teams of testers to travel—frequently internationally—to the locations of the remote networks and perform application testing under actual circumstances. However, this requires much logistical planning and substantial resources to transport not only personnel, but testing equipment as well.

Therefore, what is needed is a system and method that overcomes these significant problems found in the conventional methods described above.

### SUMMARY

Embodiments of the present invention provide systems and methods for testing a communication generated by a locally sited mobile terminal with a target terminal of a geographically remote network. In one embodiment, a locally sited mobile terminal generates a communication intended for the target terminal on the geographically remote network, a probe concentrator conducts the testing of the communication with the target terminal, the probe concentrator including a local interface for receiving from the locally sited mobile terminal the communication intended for testing on the target server, and for transmitting a communication intended for the mobile terminal to the mobile terminal, and a probe concentrator network interface for transmitting the communication intended for testing on the target server, and for receiving the communication intended for the mobile terminal. A probe concentrator may additionally include a processing module for preparing for transmitting by the probe concentrator network interface the communication intended for testing on the target server, and for preparing for transmitting by the local interface the communication intended for said mobile terminal. Another embodiment provides for a remote probe, including a remote probe network interface for receiving the communication intended for testing on the target server, and for transmitting the communication intended for the mobile terminal, a remote network interface for transmitting the communication intended for testing on the target server, and for receiving the communication intended for the mobile terminal, a processing module for preparing for transmitting by the remote network interface the communication intended for testing on the target server, and for preparing for transmitting by the remote probe network interface the communication intended for the mobile terminal.

Another embodiment provides for a probe concentrator for conducting the testing of the application communication, the testing being in conjunction with a target server on a geographically remote network, the application communication generated by a locally sited cellular telephone and intended for testing on the target server. The probe concentrator includes a wireless interface for receiving from the locally sited cellular telephone the communication intended for testing on the target server, and transmitting an communication intended for the cellular telephone to the cellular telephone, a probe concentrator network interface for transmitting the communication intended for the target server, and receiving the communication intended for the cellular telephone, a processing module for preparing for transmitting by the probe concentrator network interface the communication intended for testing on the target server, and for preparing for transmitting by the wireless interface the application communication intended for the cellular telephone. A remote probe is provided, including a remote probe network interface for receiving the communication intended for testing on the target server, and transmitting the communication intended for the cellular telephone, a wireless interface for transmitting the communication intended for testing on the target server, and receiving the communication intended for said cellular telephone, a processing module for preparing for transmitting by the wireless interface the communication intended for testing on said target server, and for preparing for transmitting by the remote probe network interface said application communication intended for said cellular telephone.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a functional block diagram illustrating the overall architecture of a testing system that may be used in connection with various embodiments described herein;

FIG. 2 is a functional block diagram illustrating the data paths inherent to one example featuring a probe concentrator that may be used in connection with various embodiments described herein;

FIG. 3 is a functional block diagram illustrating the data paths inherent to one example featuring a handset simulator that may be used in connection with various embodiments described herein;

FIG. 4 is a functional block diagram of a probe concentrator that may be used in connection with various embodiments described herein;

FIG. 5 is a functional block diagram of a remote probe that may be used in connection with various embodiments described herein;

FIG. 6 is a functional block diagram of a handset simulator that may be used in connection with various embodiments described herein;

FIG. 7 is a flowchart illustrating a method for remote testing with a probe concentrator that may be used in connection with various embodiments described herein;

FIG. 8 is a flowchart illustrating a method for remote testing with a Handset simulator that may be used in connection with various embodiments described herein;

FIG. 9 is a functional block diagram of a terminal direct connection that may be used in connection with various embodiments described herein; and

FIG. 10 is a functional block diagram of a terminal used for testing that may be used in connection with various embodiments described herein;

### DETAILED DESCRIPTION

Certain embodiments as disclosed herein provide for a system allowing a user to analyze the communications of an application hosted on a mobile terminal with a remote server connected to a remote network system. In one example, an application for a handheld cellular device may be under development in California. For this example, the application has been designed to interact over a network with a responding server, and is intended to be fielded in regions including the United Kingdom, where responding servers are hosted. It is desired to test the interaction of the application, while in California, with the responding servers in the UK. The application is executed on the handheld device, and the handheld device communicates over a local cellular connection with a probe concentrator. The probe concentrator has an IP (Internet) connection, or other network connection, with a remote probe sited under the coverage of a target cellular network in the UK. The target remote cellular network includes a network pathway to the responsive servers. Application data are transmitted from the handheld device to the probe concentrator, transmitted by the probe concentrator over the Internet to the remote probe, and then transmitted by the remote probe to the responding server over the target remote cellular network. The responding server processes the application data thus transmitted and transmits responsive application data over substantially the same path in reverse. The application data thus conveyed in both directions may be captured using the probe concentrator, and further made available for observation and analysis by a user through a user interface. It may therefore be determined whether the application, locally executed on the handheld device, has interacted properly with the remote responding server in the UK, under actual conditions inherent to the remote network.

In another example, it is desired to test the application without hosting it on a handheld device, but instead to execute the application in the environment of a simulation hosted on a computer workstation. The handset simulator performs many of the operations of a probe concentrator. For example, the handset application can be executed using the handset simulator sited on customer premises in California, as in the foregoing example. The handset application generates application data which the handset simulator formats for transmission over an IP network. The handset simulator transmits the application data onto the IP network from which it is received by a remote probe under the coverage of a target remote cellular network in the UK. The remote probe reformats the data for transmission over the remote cellular network, and then transmits the data accordingly. The responding server in the UK receives the data and returns response data through the remote cellular network to the remote probe. The remote probe reformats the response data for transmission over the IP network, and transmits the data to the handset simulator. The response data thus received by the handset simulator over the IP network are reformatted according to the requirements of the handset application and passed to the handset application. The application data both transmitted and received by the handset simulator may be captured, observed, and analyzed using a user interface. Thus, the interaction of the handset application executing locally in California with the remote responding server in UK may observed and debugged under the actual conditions of the remote network without the need for physical travel and equipment transport to the UK.

According to another embodiment, a terminal executing a test application can connect directly through a network to a remote probe, which creates and maintains a connection to a target remote network. In one example, the terminal is a Personal Digital Assistant (“PDA”) connected to the Internet through a built-in port, including a USB, Ethernet, and RS-232 port, and the remote network is a geographically remote cellular phone system from which a target server is accessible. From the perspective of the PDA, the test application connects with the remote cellular phone system transparently through the Internet and the remote probe in substantially the same way as it would were the PDA physically present and executing the application under the coverage of the remote cellular phone network. Through this connection, the application sends, and receives, application data to and from the target server. The application executing on the PDA can thus interact from afar with the target server on the geographically remote cellular phone network under conditions substantially identical to actually being present at the remote site. Further, data may be captured during the interaction and examined in real time or post-test for verification, certification, and debugging purposes.

A connection management module is further provided. In one implementation, an Operation, Administration, Management & Provisioning Server (“OAM&P Server”) is hosted at a site geographically separate from probe concentrators, handset simulators, terminals, and remote probes. The OAM&P Server communicates over the IP network with the probe concentrators, handset simulators, terminals, and remote probes and facilitates network data connections between them. In another example, the probe concentrators, handset simulators, or terminal, and the OAM&P Server are connected through a common private IP network. The private IP network is in turn connected to the Internet, through which connections are made between the probe concentrators and the remote probes.

After reading this description it will become apparent to one skilled in the art how to implement the invention in various alternative embodiments and alternative applications. However, although various embodiments will be described herein, it is understood that these embodiments are presented by way of example only, and not limitation. As such, this detailed description of various alternative embodiments should not be construed to limit the scope or breadth of the present invention as set forth in the appended claims.

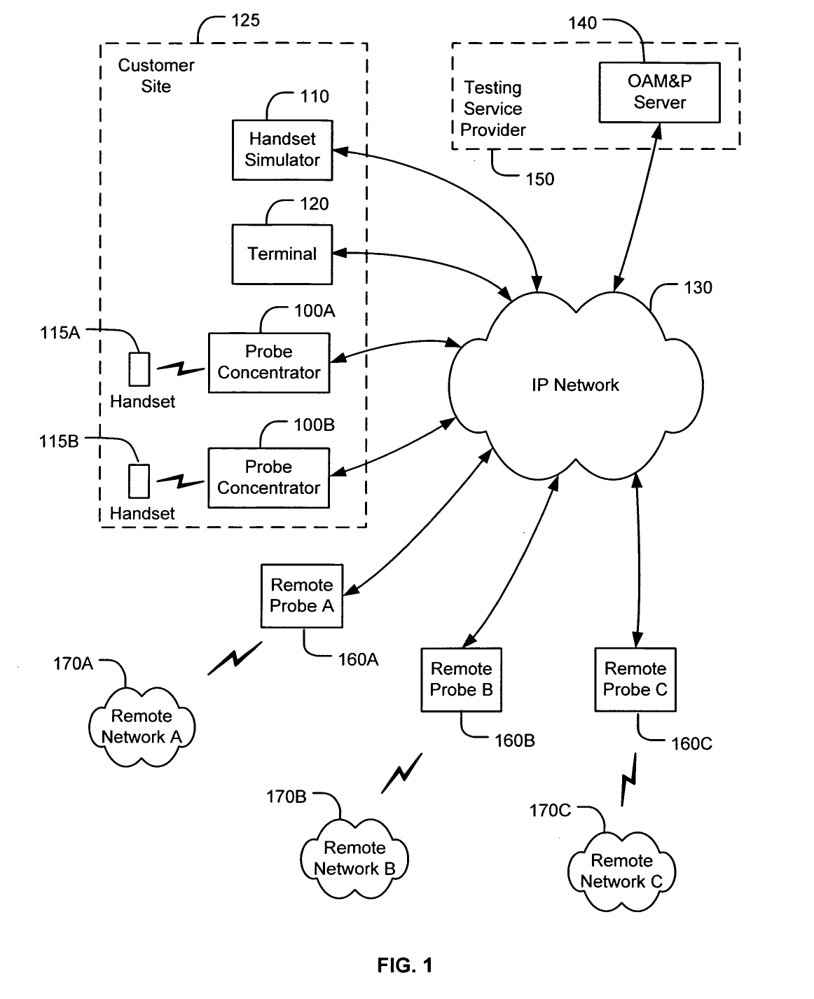

FIG. 1 is a functional block diagram illustrating one example of an overall architecture of a testing system as provided by an embodiment. The testing system includes probe concentrators 100A, 100B, handset simulator 110, and terminal 120 which can reside at a customer site 125. Shown in FIG. 1 are handsets 115A, 115B that communicate respectively with the probe concentrators 100A, 100B. The probe concentrators 100A, 100B, handset simulator 110, and terminal 120 are connected via network interfaces with a network 130. Generally, the network 130 may be any combination of any type of communication link. As one example, the network is an IP network 130. The IP network 130 may additionally be the Internet, a private IP network, a Virtual Private Network (“VPN”), a public IP network, any intermediary networks delineated by routers and/or gateways, or any combination thereof. An OAM&P server 140 functioning as a connection manager module is located at the site 150 of a testing service provider, and is also connected to the network 130. remote probes 160A-C are located at various remote sites, under the coverage of respective remote networks 170A-C, and are also connected to the network 130. The remote networks 170 A-C may be located at any geographical site on the globe. For example, remote network 170A may be a CDMA system in China, remote network 170B a GSM system in Germany, and remote network 170C a CDMA system in Uganda. In one embodiment, the remote probes 160A-C connect to the network 130 through one or more intermediary networks (not shown), including private IP networks, local area networks (“LANs”), wireless local area network (“WLANs”), or a wireless wide area network (“WWANs”). It will be appreciated that the network 130 may take many forms, and include a plurality of sub-networks managed by routers, gateways, servers, and other devices and systems.

As shown in FIG. 1, the probe concentrators 100A, 100B, handset simulator 110, and terminal 120 are connected via network interfaces through the network 130 with remote probes 160A-C. In one example, any of the probe concentrators 100A, 100B, handset simulator 110, and terminal 120 may be connected arbitrarily with any of the remote probes 160A-C. In this way, an application executing on a handset 115A, 115B, handset simulator 110, or terminal 120 can be tested from a single customer site 125 over remote networks 170A-C distributed globally, thus realizing substantial logistical convenience and efficiency. Alternatively, a single remote probe 160 may connect with and serve a plurality of geographically distributed probe concentrators 100A, 100B and handset simulators 110. That is, testing at various customer development sites 125 may be performed substantially in parallel against a particular geographically remote target network 170, again conserving significant resources through efficiency, and providing robust and authentic testing environment.

Generally, a probe concentrator 100 serves to “concentrate” a plurality of remote probes 170A-C by making the plurality available for communications to a Handset 115 at a single point. A handset simulator 110 functions similarly by concentrating a plurality of remote probes 170A-C in view of an application it hosts. A terminal 120 includes devices such as a Personal Digital Assistance (“PDA”), for example, with an interface capable of connecting with the network 130. Accordingly, it can communicate with a geographically remote target server through one of the remote probes 170A-C.

Thus, implementations of the present invention can provide a significant savings of resources, including man-hours devoted to testing and, especially, expenses related to logistics in cases where personnel must travel to the site of a remote network 170A-C in order to perform the desired testing under actual conditions. Alternatively, resources related to developing and debugging local simulations or replications of the remote networks 170A-C may be conserved, especially in light of typical deficiencies in simulation and replication fidelity.

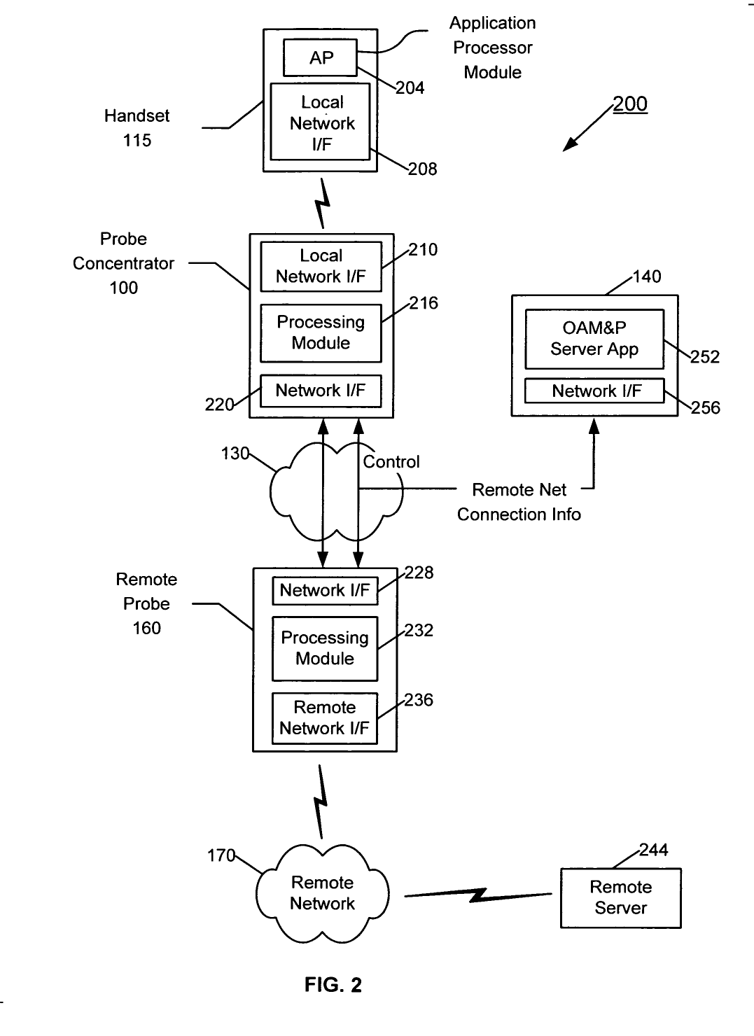

FIG. 2 is a functional block diagram illustrating some of the elements from the example testing system depicted in FIG. 1. A testing system 200 includes a locally-sited handset 115, a probe concentrator (“PC”) 100, a remote probe (“RP”) 160, and an OAM&P server 140. In one example, the handset 115 is a cellular phone handset. An application processor module 204 of the handset 115 executes a handset application that generates an application communication. The handset 115 includes a local network interface 208. As shown, the local network interface 208 is a radio frequency (“RF”) interface for communicating over a wireless communications link. In another example, the local network interface 208 is a wired interface. The local network interface 208 transmits the application communication to the PC 100, which receives the communication through a local network interface 210.

The application communication at this point is formatted according to a format for transmission using the local network interfaces 208, 210 of the locally-sited handset 115 and the PC 100. The processing module 100 performs tasks including receiving the application communication and reformatting it to a format for transmission over a network 130 (see also FIG. 1). In one embodiment, the network 130 is an IP based network. The application communication is transmitted by the PC network interface module 220 to the RP 160 over the network 130. The RP 160 includes a RP network interface module 228 through which the communication is received. One embodiment provides for Ethernet connections for either or both the PC network connection 220 of the PC 100 and the RP network connection 228 of the RP 160. Other embodiments provide for wireless connections for either or both the PC network interface module 220 and the RP network interface module 228, including WLAN and WWAN connections.

The application communication is reformatted by a RP processing module 232 in the RP 160 to a target format appropriate for transmission over the remote network 170. In one implementation, the target format conforms to the requirements of CDMA. In another implementation, the target format conforms to the requirements of GSM. It will be appreciated that many other target formats such as, for example, 3G/UTMS (“Universal Mobile Telecommunications System”), may be appropriate and are possible to implement. The application communication is then transmitted via a remote network interface module 236 in the RP 160 over the remote network 170, which routes the application communication as required to the remote server 244. The remote server 244 may be any of any type, including a mail server, web server, and database server, and it will be appreciated that it may be hosted by many types of systems, devices, and programs coupled to the remote network 170.

The remote server 244 receives the application communication and processes it, generating a remote server communication. In one example, the remote server communication may include information in response to a query in the application communication. In another example, the remote server communication may include a diagnostic error report according to a transmission or processing error that has occurred with respect to the application communication. The remote server communication is transmitted onto the remote network 170 by the remote server 244, and received by the RP through the remote network interface module 236. It will be appreciated that a remote server communication need not be in response to an application communication, as exemplified in the foregoing. Instead, a remote server communication may be generated in response to an event at the remote server 244, such as the arrival of an email intended for the handset 115.

The remote server communication, in a format conforming to the transmission requirements of the remote network 170, is reformatted by the RP processing module 160. The formatted remote server communication is then transmitted onto the network 130 to the PC 100. The remote server communication is then received by the PC 100 at the PC network interface module 220.

The received remote server communication is reformatted to a format for transmission using the local network interface 210. Reformatted, the remote server communication is transmitted using the local network interface 210 to the handset 115. The handset 115 receives the transmitted remote server communication using the local network interface 208. A user performing application testing with the handset 115 may then observe the communication test results.

One embodiment provides for a PC 100 to perform tasks in addition to reformatting. In one implementation, the PC 100 captures application and remote server communications for storage and analysis (not shown in FIG. 2). A user interface (also not shown) may be included, with which a user may observe communication data, and enter control inputs for managing, analyzing, and displaying captured communication data. In one implementation, a user may initiate calls and data connections from the PC 100 to a RP 170.

In another embodiment, the OAM&P server 140 shown in FIG. 2 is used to initiate and control calls and connections between a PC 100, a RP 160, and a remote network 170. In one implementation, the remote network 170 is a cellular telephone network. When a testing transaction is desired, the OAM&P server 140 may be requested to set up the required connections over the second and cellular networks. In one example, a request for call initialization (“call request”) may be generated by a user through a PC 100. The call request is transmitted from the PC network interface module 220 of the PC 100 to the OAM&P server 140 over the network 130 and received by the OAM&P server 140 through a server network interface 256. The call request is processed by an OAM&P Server application 252 executing on the OAM&P server 140 and appropriate call control signals generated. The call control signals are formatted and passed to the Server network interface 256 for transmission to the PC 100 and the RP 160 over a network 130.

In one embodiment, referring to FIG. 2, call control signals received by the PC 100 through the PC network interface module 220 include information for setting up a connection to a particular RP 160 over the network 130. Call control signals received by the target RP 160 include information for setting up a connection to the PC 100 over the network 130, and for setting up the cellular call or data connection with the remote network 170. In other embodiments, the OAM&P server 140 controls other, additional aspects of PC 100 and RP 160 operation.

Separate voice and data channels are typically used over cell networks to transport various types of content. Accordingly, voice communications normally take place over a voice channel and data communications such as email and web browsing take place over data channels. In particular, however, Short Messaging Service (“SMS”) messages comprising text data are typically transmitted over a voice channel. These messages are often in response to a communication to a server accessible over the cell network. Moreover, “push SMS” messages are messages issued by servers used in many cellular systems to notify a handset 115, such as a cell phone, of some event, such as the arrival of email. Thus, when email arrives at the server, the server simply sends a push SMS message to the cell phone, and avoids the burden of having to field periodic calls from the cell phone to check for email.

Because the interactions between the application running on the handset 115 and remote server 244 comprise primarily data communications over data channels, related push SMS messages conveyed on a voice channel will require different handling. Accordingly, the RP 160 is configured to receive a SMS message and encapsulate it according to transport requirements of the network 130. Examples of network transport formats include TCP/IP and UDP/IP. The RP 160 then transmits the encapsulated SMS message onto the network 130 for transport to the PC 100. The PC 100 receives the encapsulated SMS message and de-encapsulates it for processing using the processing module 216. The de-encapsulated SMS message is transmitted to the handset 115.

In one embodiment, an application communication is received from a locally-sited handset 115 through the local network interface 210 over a data channel. The communication is reformatted for transport over the network 130 by encapsulating it in a network message according to a protocol such as TCP/IP or UDP/IP. The message is transmitted by the network interface module 220 on the network 130 and received through a network interface module 228. The received message is de-encapsulated and the application communication contained is transmitted by the remote network interface module 236 on a data channel of the remote network 170. A remote server 244 receives the application communication on the data channel, and responds by transmitting a remote server communication over the data channel of the remote network 170. The remote server communication is received from the data channel using the remote network interface module 236, encapsulated in a network message according, again, to a protocol such as TCP/IP or UDP/IP, and transmitted using the network interface module 228 onto the network 130. The message is received using the network interface module 220. The application communication is de-encapsulated from the received message and transmitted by the local network interface 210 on a data channel from which it is received by the handset 115.

In another embodiment, the remote server 244 transmits a push SMS message onto a voice channel of the remote network 170. The push SMS message is received from the voice channel at the remote network interface module 236, encapsulated in a network message according to a protocol such as TCP/IP or UDP/IP, and transmitted at the network interface module 228 onto the network 130. The network message is received at the network interface module 220, and the push SMS message is de-encapsulated and transmitted at the local network interface 210 on a voice channel from which it is received by the handset 115.

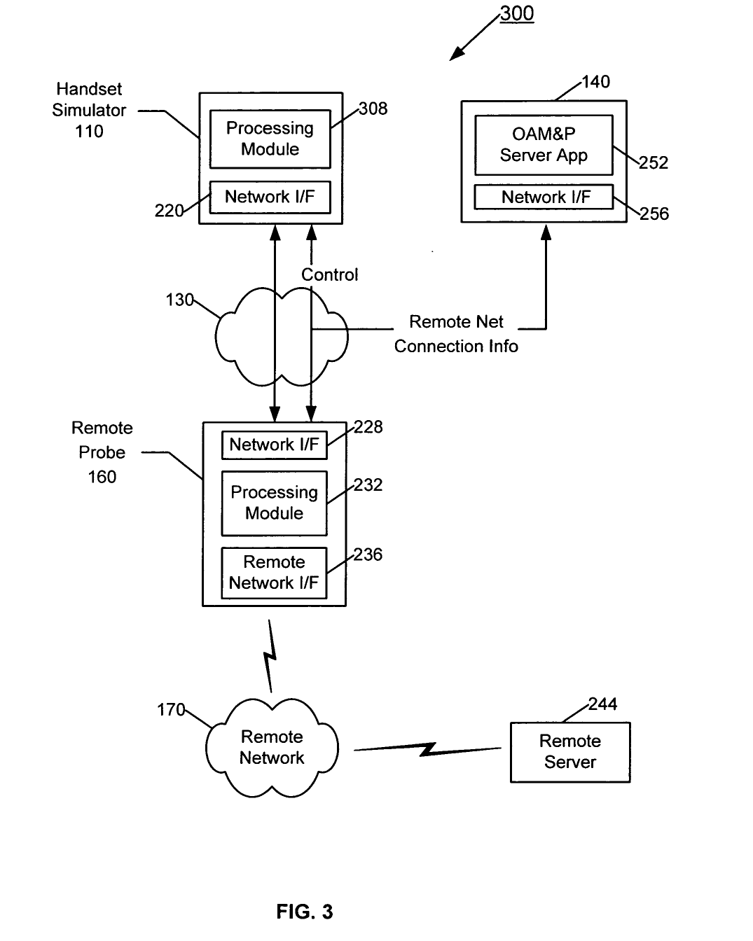

FIG. 3 is a diagram illustrating data paths in one embodiment featuring a handset simulator. A testing system 300 according to one implementation includes a handset simulator (“HS”) 110, a remote probe (“RP”) 160, and an OAM&P server 140. The OAM&P server is generally an implementation of a connection management module. A processing module 308 of the HS 110 executes a handset application that generates an application communication. The HS 110 includes a network interface module 220. The application communication at this point is formatted for transmission over a network 130. The network 130 is, for example, an IP based network, including the use of TCP/IP and UDP/IP protocols. The formatted application communication is transmitted by the network interface module 220 to the RP 160 over the network 130. The RP 160 includes a RP network interface module 228 with which the transmitted application communication is received. One embodiment provides for Ethernet connections for either or both the network connection 220 of the HS 110 and the RP network connection 228 of the RP 160. Other embodiments provide for wireless connections for either or both the network connection 220 of the HS 110 and the RP network connection 228 of the RP 160, including WLAN and WWAN connections.

The received application communication, in a network format, is reformatted by a RP processing module 232 from the network format to a target format appropriate for transport over the remote network 170. In one implementation, the target format conforms to the requirements of CDMA. In another implementation, the target format conforms to the requirements of GSM. It will be appreciated that many other target implementations, including, for example, 3G/UMTS, may be appropriate. The reformatted application communication is then transmitted at the remote network interface module 236 of the RP 160 onto the remote network 170, which routes the application communication as required to a remote server 244.

The remote server 244 receives the application communication and processes it, generating a responsive remote server communication. In one example, the remote server communication may include data in response to a query included by the application communication. In another example, the remote server communication may include a diagnostic error report according to a transmission or processing error that has occurred with respect to the received application communication. In any case, the remote server communication is transmitted onto the remote network 170 by the remote server 244, and received by the RP through the remote network interface module 236. It will be appreciated that a remote server communication need not be in response to an application communication, as exemplified in the foregoing. Instead, a remote server communication may be generated by any remote server 244 with no previous interaction with a RP 160, PC 100, HS 110, handset 115, or terminal 120.

The remote server communication, in a format conforming to the transmission protocol of the remote network 170, is reformatted by the processing module 232 to the network format. The network-formatted remote server communication is then transmitted by the IP network interface module 228 over the network 130. The network-formatted remote server communication is then received by the HS 110 through the network interface module 220. A user performing application testing with the HS 110 may then observe the communication test results.

In another embodiment, the OAM&P server 140 shown in FIG. 3 is used to initiate and control calls and connections between the HS 110, the RP 160, and the remote network 170. In one implementation, the remote network 170 is a cellular telephone network. When a testing transaction is desired, the OAM&P server 140 may be requested to set up the required network and cellular connections. In one example, a call request may be generated by a user through a HS 110. The call request is transmitted from the network interface module 220 of the HS 110 to the OAM&P server 140 over a network 130 and received by the OAM&P server 140 through an included Server network interface 256. The received call request is passed to an OAM&P Server application 252 executing on the OAM&P server 140. The call request is processed and appropriate call control signals generated. The call control signals are network-formatted and transmitted to the HS 110 and the RP 160.

In one embodiment, referring to FIG. 3, call control signals received by the HS 110 through the network interface module 220 include information for setting up a network connection to a particular RP 160. Call control signals received by the target RP 160 include information for setting up a network connection to the HS 110, and for setting up the call or data connection with the remote network 170. In one embodiment, the OAM&P server 140 controls other, additional aspects of HS 110 and RP 160 operation.

Separate voice and data channels are typically used over cell networks to transport various types of content. Accordingly, voice communications normally take place over a voice channel and data communications such as email and web browsing take place over data channels. In particular, however, SMS messages comprising text data are frequently transmitted instead over a voice channel. These messages are often in response to a communication to a server accessible over the cell network. Moreover, push SMS messages are messages issued by servers used in many cellular systems to notify a handset 115, such as a cell phone, of some event, such as the arrival of email. Thus, when email arrives at the server, the server simply sends a push SMS message to the cell phone, and avoids the burden of having to field periodic calls from the cell phone to check for email.

When the interactions between the application running on the handset simulator 110 and remote server 244 comprise primarily data communications over data channels, related push SMS messages conveyed on a voice channel will require different handling.

The RP 160 is configured accordingly to receive a SMS message and encapsulate it according to transport requirements of the network 130. Examples of possible protocols for the network 130 include TCP/IP and UDP/IP. The RP 160 then transmits the encapsulated SMS message onto the network 130 for transport to the HS 110. The HS 110 receives the encapsulated SMS message and de-encapsulates it for processing with the processing module 308.

In one embodiment, an application communication is generated and formatted for transport over the network 130 by encapsulating it in a network message according to a protocol such as TCP/IP or UDP/IP. The message is transmitted at the network interface module 220 onto the network 130 and received at a network interface module 228. The received message is de-encapsulated and the application communication contained is transmitted at the remote network interface module 236 on a data channel of the remote network 170. A remote server 244 receives the application communication on the data channel, and responds by transmitting a remote server communication over a data channel of the remote network 170. The remote server communication is received from the data channel at the remote network interface module 236, encapsulated in a network message according, again, to a protocol such as TCP/IP or UDP/IP, and transmitted at the network interface module 228 onto the network 130. The message is received at the network interface module 220. The application communication is then de-encapsulated from the received message.

In another embodiment, the remote server 244 sends a push SMS message over a voice channel of the remote network 170. The push SMS message is received from the voice channel at the remote network interface module 236, encapsulated in a network message according to a protocol such as TCP/IP or UDP/IP, and transmitted at the network interface module 228 onto the network 130. The network message is received at the network interface module 220, and the push SMS message is de-encapsulated and made accessible to the application executed at the processing module 308.

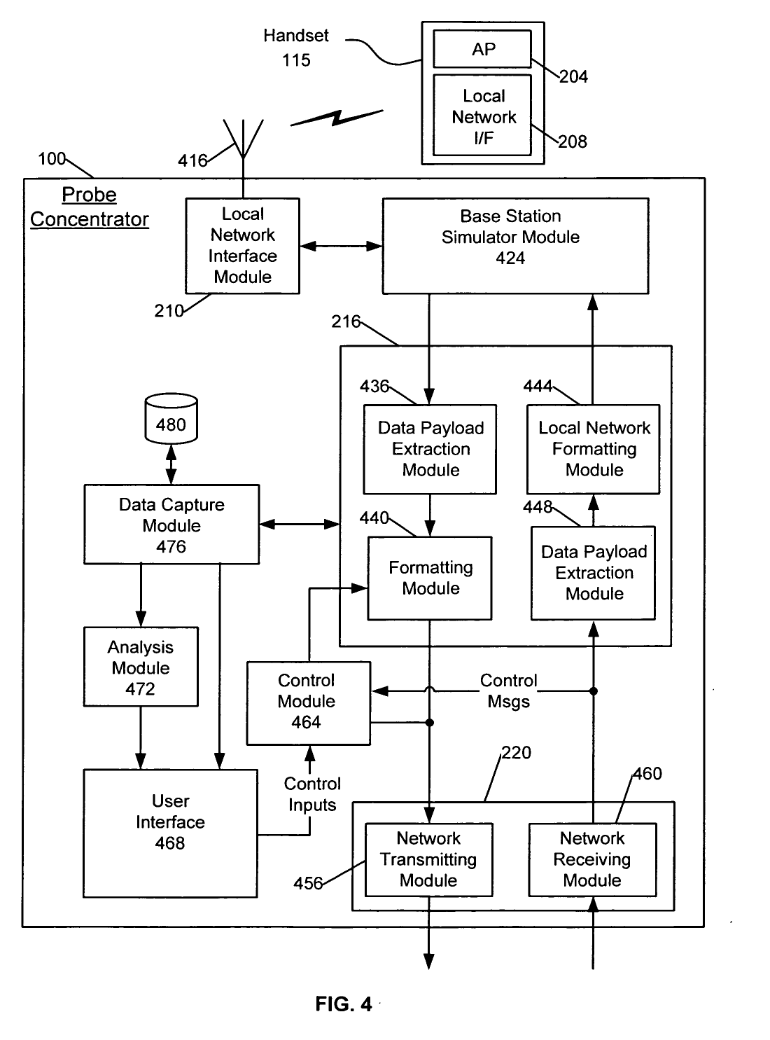

FIG. 4 is a functional block diagram of a probe concentrator 100 that may be used in connection with various embodiments described herein. As shown in the example testing system of FIG. 4, a probe concentrator (“PC”) 100 includes an RF antenna 416, and a local network interface 210, including an RF interface. The PC 100 further includes a processing module 216 that has an application data payload extraction module 436 and a network formatting module 440. The PC 100 may further include a base station simulation module 424, which may provide base station and base station controller functionality. With this component, the PC 100 can provide a simulated cellular network interface to the handset 115 when it is a cellular handset. A network interface module 220 includes a network transmitting module 456 and receiving module 460. The PC 100 may also include a control module 464, a user interface 468, an analysis module 472, a data capture module 476, and storage 480.

According to one example, an application processor module 204 of a locally-sited handset 115 executes an application that generates an application communication. The application communication is formatted according to requirements of the local network interface 208 and transmitted onto the local network to the PC 100. In one embodiment, the local network is a wireless system. In one implementation, the local network format conforms to the requirements of CDMA. In another implementation, the local network format conforms to the requirements of GSM. It will be appreciated that many other target formats such as, for example, 3G/UTMS may be appropriate and are possible to implement.

In one implementation, a wireless signal carrying the application communication is received by the PC 100 using an antenna 416 coupled to the local network interface 210. Assuming for the purposes of explanation that the local network interface 210 is a wireless cellular network interface, the signal is processed by the base station simulator 424, thus simulating a typical cellular telephone call or data connection. The application communication at this point is in a format conforming to cellular network transport, and the application data resides in the payload partition of the message comprising the application communication. Accordingly, the data payload of the message is extracted by the application data payload extraction module 436. Alternatively, the entire message is captured. The extracted data payload, or the entire captured message, is then encapsulated into the payload partition of one or more network-formatted messages by the network formatting module 440. The network-formatted messages are addressed appropriately for the target remote probe (“RP”) 160 (not shown). The network-formatted messages including the application communication are then transmitted onto a network 130 to the RP 160 by the network transmitting module 456 of the network interface module 220.

As discussed above with regard to FIG. 2, a network-formatted remote server communication is transmitted by the RP 160 onto the network 130 to the PC 100. Referring to FIG. 4, the PC 100 receives network-formatted messages including the remote server communication with the network receiving module 460 of the PC network interface module 220. The data payloads of the messages comprising the remote server communication are extracted by another data payload extraction module 448. The extracted data are encapsulated in the payload partitions of messages formatted according to the protocol of the local network by a local network message formatting module 444. The formatted messages are typically addressed to appropriately to the handset 115 for transport over a data channel of the local network. SMS messages, such as a push SMS from a remote server 244, are formatted according to the requirements of a voice channel on the local network. The formatted messages containing the remote server communication are then processed by the base station simulation module 424, and provided as signals to the network interface 210 for transmitting with the antenna 416 to the locally-sited handset 115 over the local network. The transmitted signals are received at the handset 115 by the local network interface 208. The application processor module 204 then extracts the remote server communication. A user performing application testing with the HS 110 may then observe the communication test results.

In one embodiment, referring to FIG. 2, call control signals may be received by the PC 100 through the network interface module 220 from the OAM&P server 140 that include information for setting up a network connection to a particular RP 160. Other control information may also be included. Referring again to FIG. 4, in one implementation, the call control signals are received by the network receiving module 460 of the network interface module 220 and routed to a control module 464 where the call information is extracted. That information is then used by the network formatting module 440 to address outgoing network-formatted messages. In one embodiment, the information includes the IP address of a target RP 160.

In one embodiment, a user interface 468 is provided with which a user may enter control inputs to affect various operational parameters of the PC 100. Such control inputs are entered at the user interface 468 and used by the control module 464.

In another example, a data capture module 476 is provided, which is operable to capture from the processing module 216 any application or remote server communication during operation. In one example, application and remote server communications formatted in any message format which the processing module 216 is capable of handling are available for capture, including extracted message payloads comprising the actual application and remote server communication data. In another example, any portion of a message may be captured, including header and addressing partitions. One embodiment also provides storage 480, into which the data capture module 476 may put captured data.

In another embodiment, an analysis module 472 is provided. In one example, the analysis module 472 draws captured data from the data capture module 476 and performs analysis tasks on the data according to user requests. As an example, the user requests may be for automatic analysis processing. In another example, the user makes spontaneous, real-time requests for various analysis tasks. The analysis module may further draw data from the data capture module 476 that are captured from the processing module 216 in real-time, or it may draw historical data fetched by the data capture module 476 from storage 480. It will be appreciated that many different analysis tasks may be performed by an analysis module 472.

In another embodiment, a user interface 468 may be used to view and manipulate information. For example, a user performing tests can enter commands with the user interface 468 to specify analysis tasks to be executed by the analysis module 472, to start or stop various modes of data capture using the data capture module 476, and to cause desired types of data to be saved or recalled from storage 480. Data and analysis results may be displayed on the user interface, as well as system operational parameters of the PC 100 and its components. It will further be appreciated that a user interface 468 such as that contemplated in this embodiment is a versatile component and can be used in many ways not specifically mentioned herein.

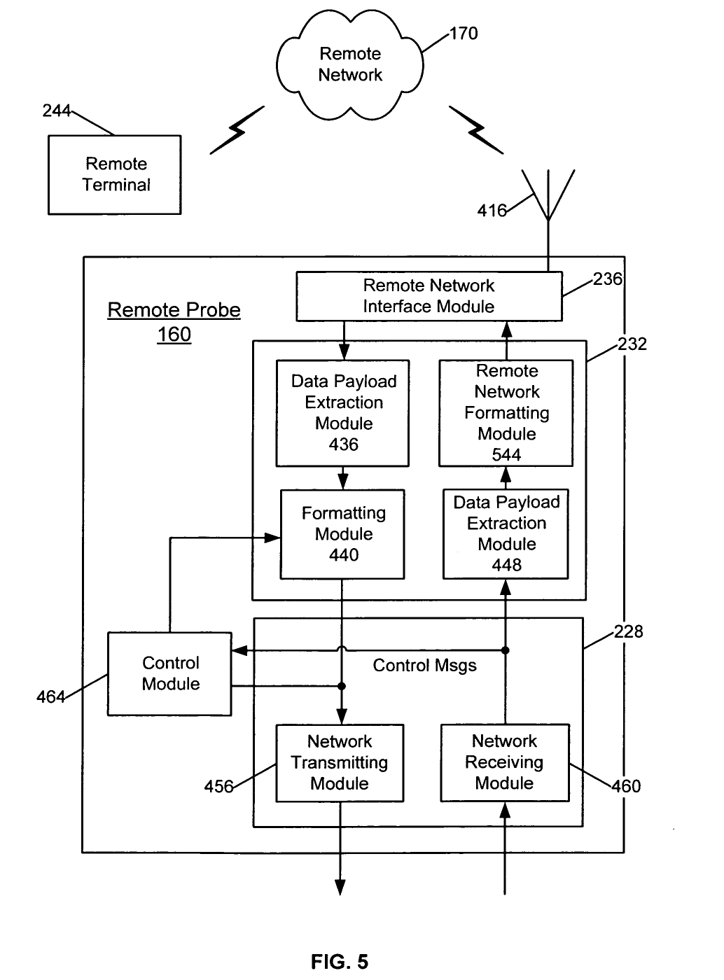

FIG. 5 is a functional block diagram of a remote probe 160 that may be used in connection with various embodiments described herein. As shown by the example testing system of FIG. 5, a remote probe (“RP”) 160 may include a RF antenna 416, and a remote network interface module 236 including a RF interface. The RP 160 typically includes also a processing module 232 having data payload extraction modules 436, 448, a network formatting module 440, and a remote network formatting module 544. A RP network interface module 228 includes a network transmitting module 456 and a network receiving module 460. The RP 160 may also be coupled to a control module 464.

As discussed above with regard to FIG. 2, network-formatted application communications are received by the RP 160 from the PC 100 over a network 130. Referring to FIG. 5, the RP 160 receives the network-formatted messages including the application communication with the network receiving module 460 of the IP network interface module 228. The data payloads of the messages comprising the application communication are extracted by an application data payload extraction module 448 of the processing module 232. The extracted data payload, is encapsulated by a remote network message formatter 544 into the payload partitions of one or more messages formatted according to the requirements of the remote network 170. Alternatively, a payload of a received application communication is itself a complete message already formatted according to the requirements of the remote network 170. In that case, formatting is not necessary. In general, these formatted messages are addressed to the remote server 244, to which they are sent over the remote network 170 using the remote network interface module 236. In one embodiment, the remote network 170 is a wireless cellular network operating under CDMA protocol. In another embodiment, the remote network 170 is a wireless cellular network operating under GSM protocol. It will be appreciated that many other target formats such as 3G/UTMS may be appropriate and are possible to implement.

Continuing with the example embodiment of a wireless cellular remote network 170, remote server communications from the remote server 244 are conveyed by wireless cellular signal and received by the RP 160 at an antenna 416 coupled to the remote network interface module 236. The remote server communications at this point are typically in a format conforming to a wireless cellular network protocol, residing in the payload partition of the transport messages. In one embodiment, the data payloads of the messages comprising the remote server communication are extracted at the data payload extraction module 436 of the processing module 232. The extracted data are then encapsulated in the payload partitions of network-formatted messages by a network formatting module 440. Alternatively, the entire received message is encapsulated inside one or more payload partitions of the network-formatted messages. The network-formatted messages are addressed appropriately for the target probe concentrator (“PC”) 100 (not shown). The network-formatted messages containing the remote server communication are transmitted at the network transmitting module 456 of the RP network interface module 228 onto the network 130 to the PC 100.

The data payload extraction module 436 is also configured to recognize a SMS message, such as a push SMS from the remote server 244, received on a voice channel of the remote network 170 at the remote network interface module 236. In this case, the SMS message can be encapsulated in its entirety by a network-formatted message by the formatting module 440. Alternatively, the text/data content of the SMS message can be extracted at the data payload extraction module 436 and encapsulated by a network-formatted message by the formatting module 440. Following encapsulation, the network-formatted message is transmitted onto the network 130 at the network transmitting module 456.

In one embodiment, referring to FIG. 2, call control signals may be received by the RP 160 through the RP network interface module 228 from an OAM&P server 140 that include information for setting up a network connection to a particular PC 100. Other control information may also be included. Referring again to FIG. 5, in one implementation, the call control signals are received by the network receiving module 460 of the RP network interface module 228 and routed to a control module 464 where the call information is extracted. That information may then be used to address outgoing network-formatted messages by the network formatting module 440. In one embodiment, the information includes the IP address of a target PC 100.

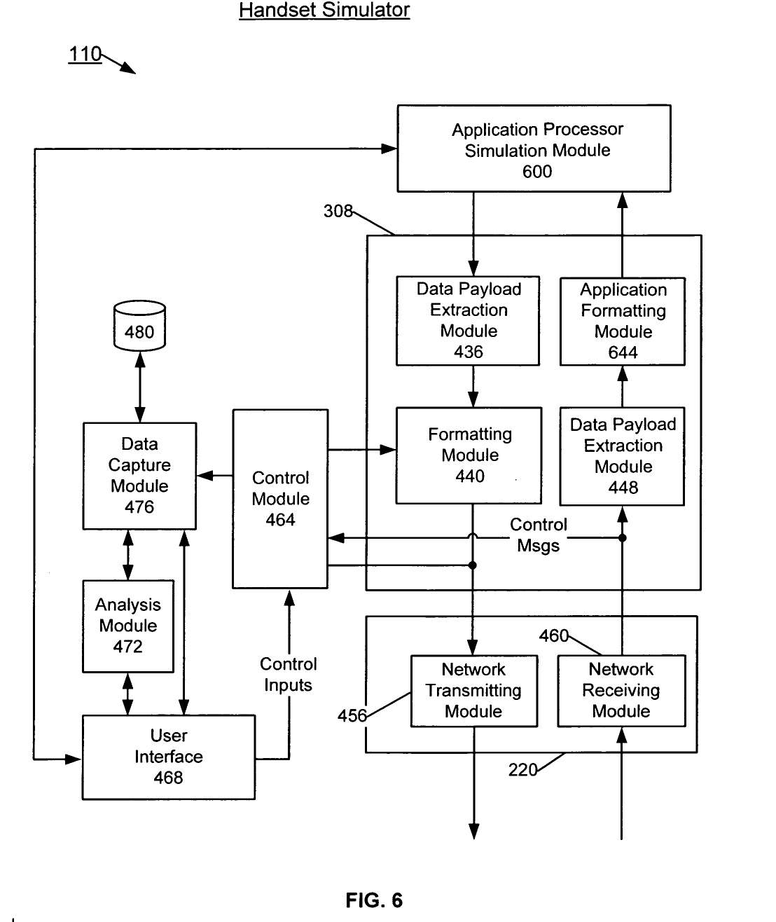

FIG. 6 is a functional block diagram of a handset simulator 110 that may be used in connection with various embodiments described herein. As shown in the example testing system depicted in FIG. 6, a handset simulator (“HS”) 110 includes a HS application processor simulator 600. The HS 110 may further include a processing module 308 having a network formatting module 440, application data payload extraction modules 436, 448. In one embodiment, the processing module 308 may also have a control module 664. A network interface module 220 includes a network transmitting module 456 and a network receiving module 460. The HS 110 may further include a user interface 468, an analysis module 472, a data capture module 476, and storage 480. The handset simulator 110 operates substantially as does a probe concentrator 100, except that the functionality of a locally-sited handset 115 is expressed in a simulator executing in the environment of the application processor simulation module 600. An application that hosted on a handset 115 may therefore be hosted under simulation, thereby eliminating the need for testing the application on a handset 155 through a communication link on a local wireless network.

According to one embodiment, the handset application processor simulation module 600 executes an application that generates an application communication formatted for the target remote network 170 (not shown). The application communication data are extracted by a data payload extraction module 436. The extracted data payload is then encapsulated by the formatting module 440 in the payload partitions of messages formatted according to a protocol of the network 130. Alternatively, the entire application communication is encapsulated in the payload partitions of network-formatted messages. The network-formatted messages are addressed appropriately for the target remote probe (“RP”) 160 (not shown). The network-formatted messages including the application communication are then transmitted by the network transmitting module 456 of the network interface module 220 to the RP 160 over a network 130.

As discussed above with regard to FIG. 3, a responsive network-formatted remote server communication is transmitted by the RP 160 to the HS 110 over the network 130. Referring to FIG. 6, the HS 110 receives network-formatted messages including the remote server communication at the network receiving module 460 of the network interface module 220. The data payloads of the network-formatted messages comprising the remote server communication are extracted by a data payload extraction module 448. The extracted data payload is then formatted according to the requirements of the application processor simulation module 600. Alternatively, the data payloads of the received messages comprising the remote server communication may comprise complete encapsulated messages already formatted according to the requirements of the application simulation processor module 600. In that case, the extracted data payload is accessed by the application simulation processor module 600. In many cases, the application executing in the environment of the application processor simulation module 644 is configured to communicate over a data channel, such as a data channel of a wireless cell network. As discussed above, however, important data may also be conveyed with SMS messages over the voice channels. Accordingly, the data payload extraction module 448 is also configured to recognize a SMS message, such as a push SMS message from a remote server 244. Once extracted, a SMS message is formatted by the application formatting module 644 appropriately for the application executing in the environment of the application processor simulation module 600. For example, the application may be configured to accept SMS messages over a voice channel. The SMS message would therefore be formatted according to the manner in which the application under testing would expect it from a voice channel.

In one embodiment, referring to FIG. 2, call control signals may be received by the HS 110 through the network interface module 220 from the OAM&P server 140 that include information for setting up a network connection to a particular RP 160. Other control information may also be included. Referring again to FIG. 6, in one embodiment, the call control signals are received by the network receiver module 460 of the network interface module 220 and routed to a control module 464 where the call information is extracted. That information is then used, for example, by the formatting module 440 to address outgoing IP formatted messages. In one example, the information includes the IP address of a target RP 160.

In one embodiment, a user interface 468 is provided with which a user may enter control inputs to affect various operational parameters of the HS 110. As such, the control inputs may be entered at the user interface 468 for use by the control module 464.

A data capture module 476 is provided, which is operable to capture any application and remote server communication at any stage of processing from the processing module 308. In one example, application and remote server communication data formatted in any message format which the processing module 308 is capable of handling are available for capture, including extracted message payloads comprising application and remote server communication data. Additionally, any portion of a message may be captured, including header and addressing partitions. One embodiment further provides storage 480, into which the data capture module 476 may put captured data.

In another example, an analysis module 472 is provided. The analysis module 472 draws captured data from the data capture module 476 and performs analysis tasks on the data according to user requests. For example, the user requests may be for automatic analysis processing. Or, the user may make spontaneous, real-time requests for various analysis processing. The analysis module may further draw data from the data capture module 476 that are captured from the processing module 308 in real-time, or it may draw historical data fetched by the data capture module from storage 480. It will be appreciated that many different analysis tasks may be performed an analysis module 472.

In one implementation, a user interface 468 may be used to view and manipulate information. For example, a user performing tests can enter commands with the user interface 468 to specify analysis tasks to be executed by the analysis module 472, to start or stop various modes of data capture using the data capture module 476, and to cause desired types of data to be saved or recalled from storage 480. Data and analysis results may be displayed on the user interface, as well as system operational parameters of the HS 110 and its components. It will be recognized that a user interface 468 such as that contemplated in this embodiment is a versatile component and can be used in many ways not specifically mentioned herein.

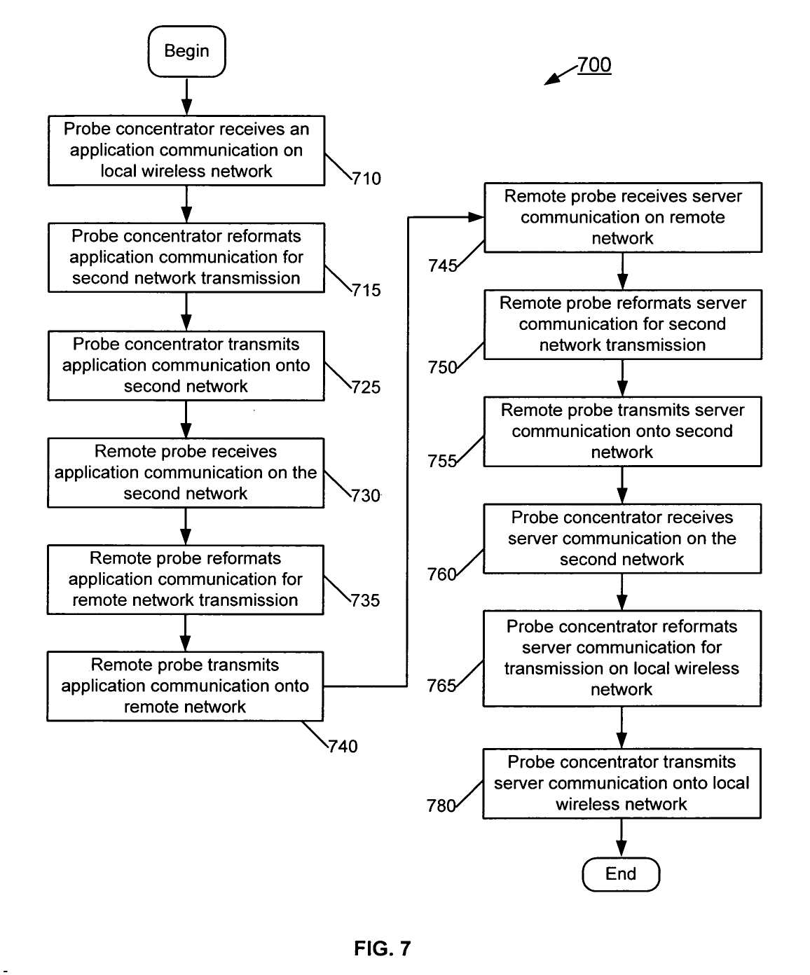

FIG. 7 is a flowchart illustrating a method 700 for remote testing with a probe concentrator 100, for example, that may be used in connection with various embodiments described herein. A probe concentrator (“PC”) 100 receives 710 an application communication over a local wireless network. Typically, the application communication is received on a data channel of the local wireless network. In one embodiment, the local wireless network is a CDMA based cellular network. Alternatively, the local wireless network can be a GSM based cellular network. It will be appreciated that many other types of communication networks may be implemented, including 3G/UTMS. The PC reformats 715 the application communication from a format used for communications over the local wireless network to a format appropriate for the second network transmission. In one embodiment, the format is an IP format. Generally, the second network is the network 130 of FIG. 1. As discussed in relation to FIG. 1, the network 130 may be an IP network, and additionally the Internet, a private IP network, a Virtual Private Network (“VPN”), a public IP network, and any intermediary collection of networks delineated by routers and/or gateways, or any combination thereof. The PC transmits 725 the application communication onto the second network.

The application communication is received from over the second network by a RP 160. The RP 160 reformats 735 the application communication to a format appropriate for the remote network 170, where the remote network 170 is typically geographically remote in relation to the local wireless network. The RP transmits 740 the application communication onto the remote network 170.

The RP subsequently receives 745 a remote server communication from a remote server 244 situated on the remote network 170. In one example, the communication from the remote server 244 is responsive to the application communication. In another example, the communication from the remote server 244 includes a push SMS message sent via a voice channel of the remote network 170. The remote server communication is reformatted 750 to the format of the second network. The remote server communication is then transmitted 755 onto the second network to the PC 100.

The PC 100 receives 760 the remote server communication. The PC reformats 765 the remote server communication to a format appropriate for a data channel of the local wireless network. The PC transmits 780 the remote server communication onto the local wireless network. Additionally, the PC 100 may at this time also capture and store application and remote server communications. In one embodiment, captured communications may be analyzed and displayed. The handset simulator 110 is also operable at this point to distinguish a received push SMS message, which is treated as a communication over a wireless voice channel. That is, the push SMS message would be transmitted onto a voice channel of the local wireless network.

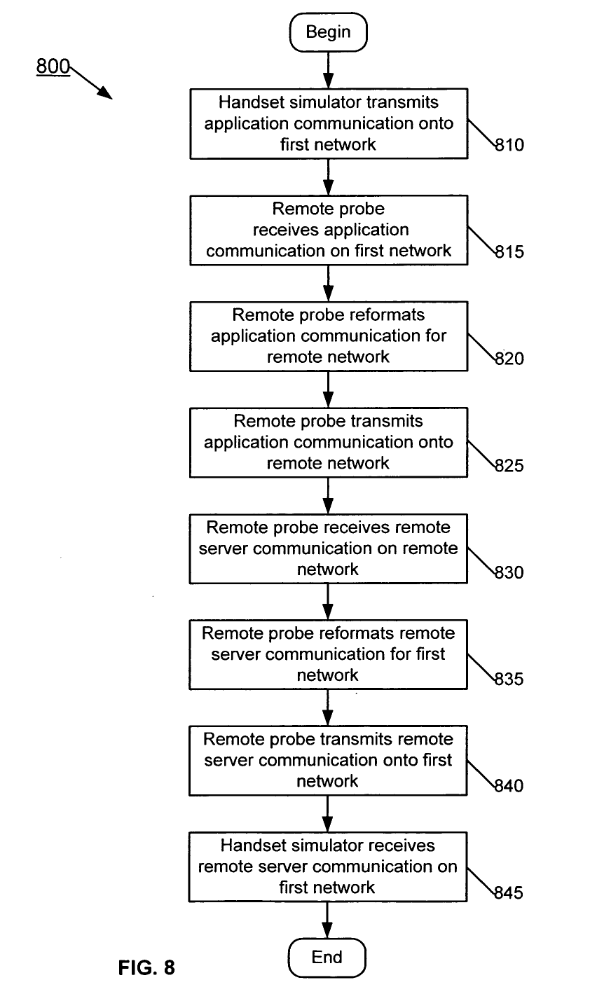

FIG. 8 is a flowchart illustrating a method 800 for remote testing with a handset simulator that may be used in connection with various embodiments described herein. A handset simulator (“HS”) 110 transmits 810 an application communication onto a first network. Generally, the first network is the network 130 of FIG. 1. In one embodiment, the first network is an IP based network. In a further embodiment, the IP based network is the Internet. Alternatively, the first network includes a private network, a public network, and a virtual private network. In general, any IP based network is regarded as also operable to use TCP/IP and UDP/IP protocols.

A remote probe (“RP”) receives 815 the application communication from the first network. The RP reformats 820 the application communication to a format appropriate for the remote network 170. The RP transmits 825 the application communication onto the remote network 170, where the remote network 170 is typically geographically remote in relation to the HS 110.

The RP receives 830 a communication from a remote server 244 situated on the remote network 170. In one example, the communication from the remote server 244 is responsive to the application communication. In another example, the communication from the remote server 244 can include a push SMS message sent via a voice channel of the remote network 170. The remote server communication is reformatted 835 to a format appropriate for the first network. The remote server communication is transmitted 840 onto the first network to the handset simulator 110.

The handset simulator 110 receives 845 the remote server communication. Additionally, the Handset simulator 110 may at this time also capture and store the remote server communication. In one embodiment, captured application and remote server communications may be analyzed and displayed. The handset simulator 110 is also operable at this point to distinguish a received push SMS message, which is treated as a communication over a wireless voice channel. For example, a push SMS message may indicate that an email awaits downloading from the remote server 244, and the handset simulator 110 must therefore respond with an application communication requesting the download.

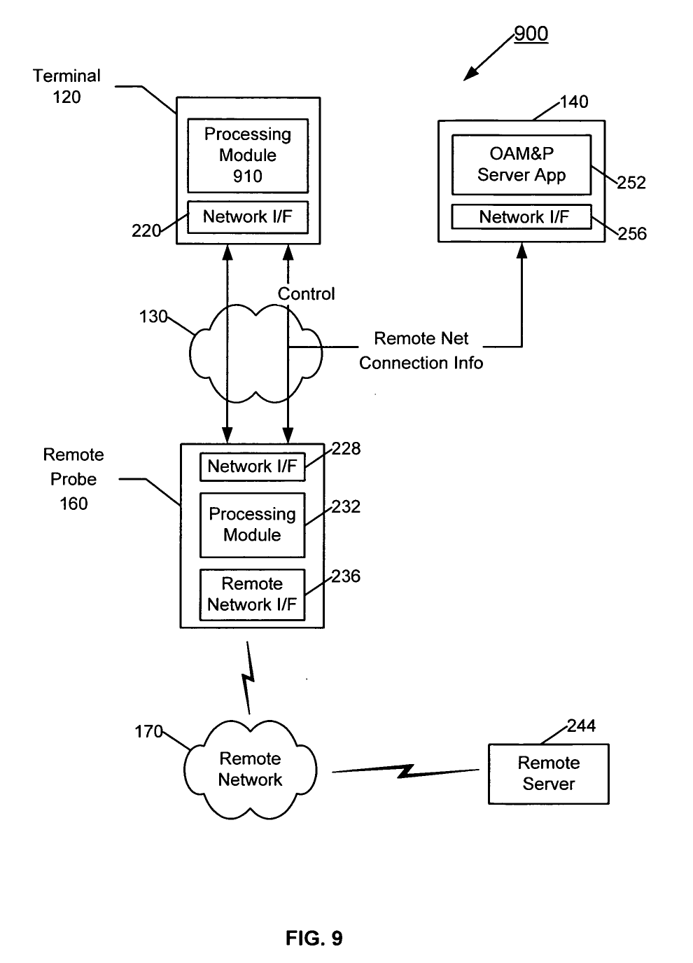

FIG. 9 is a functional block diagram illustrating data paths according to one embodiment featuring a terminal direct connection. The example testing system 900 includes a terminal 120, a remote probe (“RP”) 160, and an OAM&P server 140. In one example, the terminal 120 is a device such as a Personal Digital Assistant (“PDA”). A processing module 910 of the terminal 120 executes an application that generates an application communication, including outgoing test data. The terminal 120 includes a network interface module 220. The network interface module 220 has, for example, a wired connection such as a USB port and an Ethernet connection. The application communication at this point is formatted for transmission over a network 130, including an IP based network using TCP/IP and UDP/IP protocols. The formatted application communication is transmitted using the network interface module 220 to the RP 160 over the network 130. The RP 160 has a RP network interface module 228 with which the transmitted application communication is received. Additionally, an Ethernet or USB connection may function as the RP network connection 228 of the RP 160. Other embodiments provide for wireless connections as either or both the network connection 220 of the terminal 120 and the RP network connection 228 of the RP 160, including WLAN and WWAN connections.

The received application communication, encapsulated by a message in an appropriate network format, is reformatted by a RP processing module 232 included by the RP 160 from the network format to a target format appropriate for the remote network 170. In one implementation, the target format conforms to the requirements of CDMA. In another implementation, the target format conforms to the requirements of GSM. It will be appreciated that many other target formats may be appropriate, including, for example, 3G/UTMS. The application communication thus reformatted for the remote network 170 is then passed to a remote network interface module 236 of the RP 160. The application communication is transmitted over the remote network 170, which routes the application communication as required to the targeted remote server 244.

The remote server 244 generates a remote server communication in return. In one example, the remote server 244 generates a remote server communication including data related to a query that was included by the application communication. In another example, the remote server communication may include a diagnostic error report according to a transmission or processing error that has occurred with respect to the application communication. In any case, the remote server communication is transmitted onto the remote network 170 by the remote server 244, and received by the RP 160 through the remote network interface module 236.

The remote server communication in a format conforming to the transport protocol of the remote network 170, is reformatted to a format appropriate to the protocols of the network 130. The network-formatted remote server communication is then transmitted the terminal 120 over the network 130 using the network interface module 228. The network-formatted remote server communication is received by the terminal 120 through the network interface module 220. A user performing application testing with the terminal 120 may then observe the resulting effects on the operation of the application executing under the processing module 910 in response to the received remote server communication.

In another example, the OAM&P server 140 shown in FIG. 9 is used to initiate and control calls and connections between the terminal 120, the RP 160, and the remote network 170. In one implementation, the remote network 170 is a cellular telephone network. When a testing transaction is desired, the OAM&P server 140 may be requested to set up the required network and cellular connections. In one example, a call request may be generated by a user through a terminal 120. The call request is transmitted from the network interface module 220 of the terminal 120 to the OAM&P server 140 over the network and received by the OAM&P server 140 through an included Server network interface 256. The received call request is passed to an OAM&P Server application 252 executing on the OAM&P server 140. The call request is processed and appropriate call control signals generated. The call control signals are network-formatted and passed to the Server network interface 256 for transmission to the HS 110 and the RP 160.

In one embodiment, referring to FIG. 9, call control signals received by the terminal 120 through the network interface 620 include information for setting up an network connection to a particular RP 160. Call control signals received by the target RP 160 include information for setting up a network connection to the terminal 120, and for setting up the call or data connection with the remote network 170. The OAM&P server 140 may control other, additional aspects of HS 110 and RP 160 operation.

Separate voice and data channels are typically used over cell networks to transport various types of content. Accordingly, voice communications normally take place over a voice channel and data communications such as email and web browsing take place over data channels. In particular, however, Short Messaging Service (“SMS”) messages comprising text data are frequently transmitted over a voice channel. These messages are often in response to a communication to a server accessible over the cell network. Moreover, push SMS messages are issued by servers used in many cellular systems to notify a handset 115, such as a cell phone, of some event, such as the arrival of email. Thus, when email arrives at the server, the server simply sends a push SMS message to the cell phone, and avoids the burden of having to field periodic calls from the cell phone to check for email.

When the interactions between the application running on the terminal 120 and remote server 244 comprise primarily data communications over data channels, related push SMS messages conveyed on a voice channel will require different handling. Accordingly, the RP 160 is configured to receive a SMS message and encapsulate it according to transport requirements of the network 130. Examples of network transport formats include TCP/IP and UDP/IP. The RP 160 then transmits the encapsulated SMS message onto the network 130 for transport to the terminal 120. The terminal 120 receives the encapsulated SMS message and de-encapsulates it for processing using the application processor module 204.

In one embodiment, an application communication is generated and configured for transmission over a data channel. The communication is then reformatted for transport over the network 130 by encapsulating it in a network message according to a protocol such as TCP/IP or UDP/IP. The message is transmitted by the network interface module 220 on the network 130 and received through a network interface module 228. The received message is de-encapsulated and the application communication contained is transmitted by the remote network interface module 236 on a data channel of the remote network 170. A remote server 244 receives the application communication on the data channel, and responds by transmitting a remote server communication over the data channel of the remote network 170. The remote server communication is received from the data channel using the remote network interface module 236, encapsulated in a network message according, again, according to a protocol such as TCP/IP or UDP/IP, and transmitted using the network interface module 228 over the network 130. The message is received using the network interface module 220. The application communication is then de-encapsulated from the received message.

In another embodiment, the remote server 244 transmits a push SMS message over a voice channel of the remote network 170. The push SMS message is received from the voice channel at the remote network interface module 236, encapsulated in a network message according to a protocol such as TCP/IP or UDP/IP, and transmitted at the network interface module 228 onto the network 130. The network message is received at the network interface module 220, and the push SMS message is de-encapsulated and made accessible to the application executed by the processing module 910.

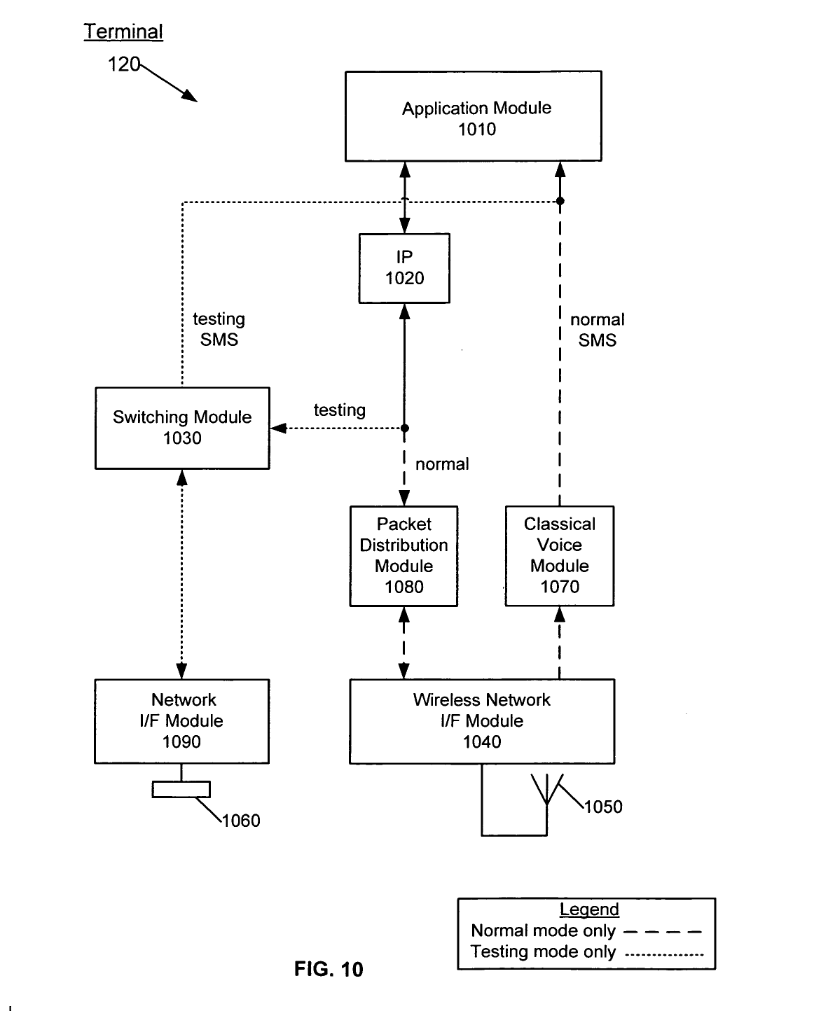

FIG. 10 is a functional block diagram of a terminal 120 that may be used in connection with various embodiments described herein. As shown in the example testing system of FIG. 10, an example of testing using a terminal 120 includes using an application module 1010, an IP module 1020, a switching module 1030, a network interface module 1090 coupled with an I/O port 1060, a network interface module 1040 coupled with a RF antenna 1050, a packet distribution module 1080, and a classical voice module 1070. A terminal 120 is typically a mobile device of some type, such as a PDA. Typically, the network interface module 1040 is a wireless network interface. In general, however, it is regarded as the “intended interface,” or “intended port,” because it is the interface/port to which the application module is bound (in the sense of binding to a network protocol stack) during normal operation (i.e., when no application testing is underway). The I/O module 1060 includes ports such as USB and Ethernet ports, but also an antenna for access to a wireless network, for example, such as an IEEE 802.11 based Wi-Fi network. It will be appreciated, however, that access to many other types of networks, wired and wireless, is possible, including those based on other wired and wireless LAN and WAN standards. Further, the network interface module 1090 is regarded as the “other interface,” or “other port,” because it is the interface/port to which the application module is bound (in the sense of binding to a network protocol stack) during application testing. The IP module 1020 may be configured for TCP/IP and UDP/IP protocols.

According to one embodiment, the application module executes an application generating an application communication intended for transport over a data channel to a remote server 244. Operating in a “normal” mode, the terminal 120 is connected to a wireless cell network, for example, and the application communication is transported over a data channel of the wireless cell network to a server also connected to the network. In a “testing” mode, by contrast, the terminal 120 is connected to an EP based network 130, for example, to which is connected a RP 160. The RP 160 is also connected to a target remote network 170—a wireless cell network, for instance—to which a remote server 244 is connected. In testing mode, then, the application communication is transported on the IP based network to the RP 160, which receives it and transmits it onto the remote network 170 on a data channel to the remote server 244.

In one example, under normal operating mode, the application communication is prepared according to an IP protocol by the IP module 1020. It is then packetized by a packet distribution module 1080 representing the networking protocol stack to which communications on the terminal 120 are normally bound. For example, the protocol stack can conform to General Packet Radio Service (“GPRS”) packetizing, used under GSM. The packetized communication is then normally transmitted onto a data channel of a wireless cell network at the wireless network interface module 1040.

The paths of normal outbound application communication processing according to the example of FIG. 10 are marked by large dashed connectors seen between the IP module 1020, the packet distribution module 1080, and the wireless network interface module 1040.

The process is substantially reversed for incoming communications. When a packetized communication is received from a data channel of the wireless cell network at the wireless network interface module 1040, it is de-packetized at the packet distribution module 1080. Data are extracted from it at the IP module 1020 for use at the application module 1010.

When a SMS message, such as a push SMS issued by a remote server 244, is received over a voice channel of the wireless cell network at the wireless network interface module 1040, it is normally processed by a classical voice module 1070 (also known as a “circuit switched data” module). Push SMS messages are frequently used to notify a terminal 120 of the occurrence of a relevant event at the server. For example, when the server receives an email intended for the terminal 120, it issues a push SMS—an unprompted notification—over a voice channel to the terminal 120 advising it of a new email awaiting download by the terminal 120. Therefore, while the application executed by the application module 1010 of the terminal 120 is generally communicating over one or more data channels, the terminal 120 must also be configured to field SMS messages over a voice channel. Received SMS messages are then processed by the application module 1010.

Similarly to the outbound communications just described, the paths for inbound communication processing, such as for remote server communications over data channels and SMS messages over voice channels, are marked in FIG. 10 by large dashed connectors between the wireless network interface module 1040, the classical voice module 1070, and the application module 1010, and between the wireless network interface module 1010, the packet distribution module 1080, and the IP module 1020.

When the terminal 120 is operating in testing mode, the application communication generated by the application module 1010 is again prepared according to an IP protocol by the IP module 1020. In testing mode, however, a switching module 1030 rebinds processing performed on the terminal 120 to the network interface module 1090, instead of to the packet distribution module 1080 to which it is normally bound. The switching module 1030 is further configured to complete any formatting required for transmitting the application communication at the network interface module 1090 through the I/O module 1060 onto the network 130.

Outbound application communication processing paths under testing mode according to the example of FIG. 10 are marked by small dashed connectors seen between the IP module 1020, the switching module 1030, and the network interface module 1090.

The foregoing is substantially reversed for incoming communications under testing mode. When a communication is received on the network 130 at the network interface module 1060, it is de-formatted at the switching module 1030, and data are extracted from it at the IP module 1020 for use at the application module 1010. The switching module 1030 is also configured to recognize a SMS message, such as a push SMS issued by a remote server 244, received on the network 130 at the network interface module 1090. As discussed above, a SMS message is normally processed by a classical voice module 1070. The distinction between voice and data channels does not apply in the context of the network 130, however, as it does to a wireless cell network. By contrast, in normal mode operation, a natural separation between voice and data channels occurs with the use of separate network protocol stacks represented by the packet distribution module 1060 and the classical voice module 1070. In testing mode, the switching module 1030 serves accordingly to separate out SMS messages from other data messages received on the network 130. SMS messages thus separated out are also formatted at the switching module 1030 to match the formatting of SMS messages processed at the classical voice module 1070 under normal operating mode. The SMS messages may then be processed by the application module 1010 as they would be under normal operating mode.

Similarly to outbound application communications just described above, the paths under testing mode for inbound communication processing, such as for remote server communications and SMS messages, are expressed in FIG. 10 with small dashed connectors between the network interface module 1090, the switching module 1030, and the application module 1010.

In another example, the switching module 1030 includes data capture functionality, operable to capture data during operation. One embodiment further provides storage functionality, into which captured data may be stored.

In another embodiment, the switching module 1030 includes analysis functionality. For instance, a user may request automatic analysis processing. Alternatively, the user may make spontaneous, real-time requests for various analysis tasks. Such analysis tasks may draw data captured in real-time, or they may draw stored data. It will be appreciated that many different analysis tasks may be performed

In another embodiment, the switching module 1030 includes a user interface used to view and manipulate information. For example, a user performing tests can enter commands with the user interface to specify analysis tasks, to start or stop various modes of data capture, and to cause desired types of data to be saved or recalled from storage. Data and analysis results may be displayed using the user interface, as well as system operational parameters of the terminal 120 and its components. It will further be appreciated that a user interface such as that contemplated in this embodiment is a versatile function and can be used in many ways not specifically mentioned herein.

Thus, according to embodiments described herein, an application hosted for testing by a handset 115, a handset simulator 110, and a terminal 120 can generate communications that are packetized for a geographically remote wireless network 170, encapsulated for transport over an intermediate network 130, received by a remote probe 160, de-encapsulated, and then transmitted onto the geographically remote network 170 for testing. In this way, valuable resources are conserved and application testing over distant networks can be conducted with unprecedented convenience and efficiency.

Those of skill in the art will appreciate that the various illustrative protocol stack layers, modules, and method steps described in connection with the above described figures and the embodiments disclosed herein can often be implemented as electronic hardware, computer software, or combinations of both. To clearly illustrate this interchangeability of hardware and software, various illustrative layers, modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a layer, module, block, or step is for ease of description. Specific functions or steps can be moved from one module, block or step to another without departing from the invention.

Moreover, the various illustrative protocol layers, logical blocks, modules, and methods described in connection with the embodiments disclosed herein can be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method for testing a wireless handset with a remote server via a geographically remote network, the handset generating an application communication and having a communication link on a local wireless network, the method comprising:
receiving on a local wireless network an application communication for testing with a remote network;
reformatting the application communication for a second network;
transmitting the application communication onto the second network;
receiving the application communication on the second network;
reformatting the application communication for a remote network geographically remote from the local wireless network;
transmitting the application communication onto the remote network;
receiving a server communication in response on the remote network;
reformatting the server communication for the second network;
transmitting the server communication onto the second network;
receiving the server communication on the second network;
reformatting the server communication for the local wireless network; and
transmitting the server communication onto the local wireless network.

2. The method of claim 1, wherein the local wireless network includes a cellular phone network.

3. The method of claim 1, wherein the remote network includes a wireless cellular phone network.

4. The method of claim 1, wherein the second network includes an IP based network.

5. The method of claim 1, further comprising the remote probe receiving a SMS message on a voice channel of the remote network.

6. The method of claim 1, further comprising capturing data for testing.

7. The method of claim 1, further comprising receiving user commands through a user interface.

8. The method of claim 7, wherein the commands are for data analysis tasks.

9. The method of claim 7, wherein the commands are for data storage or retrieval tasks.

10. The method of claim 1, further comprising using an OAM&P server to initiate and maintain a communication connection on the second network with a remote probe.

11. A probe concentrator for testing a locally sited wireless handset with a remote server via a geographically remote network, using a remote probe having a wireless communication link with the remote network, the probe concentrator comprising:
a local wireless network interface module for receiving an application communication from a locally sited wireless handset, and sending a remote server communication to the locally sited wireless handset;
a base station simulator module coupled to the local wireless network interface module, for simulating base station functionality in relation to the locally sited wireless handset;
a network interface module including
a network transmitting module for sending the application communication to a remote probe, and
a network receiving module for receiving the remote server communication from the remote probe; and
a processing module for reformatting the application communication for sending by the network interface module, and reformatting the remote server communication for sending by the local wireless network interface module.

12. The probe concentrator of claim 11, wherein the local wireless network interface module includes a cellular phone network interface.

13. The probe concentrator of claim 11, wherein the network interface module is configured to send and receive IP based messages.

14. The probe concentrator of claim 11, wherein the processing module is configured to reformat SMS messages for sending by the local wireless network interface module via a voice channel.

15. The probe concentrator of claim 11, further comprising a data capture module for capturing data for testing.

16. The probe concentrator of claim 11, further comprising a data analysis module for performing data analysis tasks for testing.

17. The probe concentrator of claim 11, further comprising data storage.

18. The probe concentrator of claim 11, further comprising a user interface module for observation and analysis of data, and accepting user commands.

19. The probe concentrator of claim 11, further comprising a control module configured to operate in conjunction with an OAM&P server for initiating and maintaining a communication connection with the remote probe.

20. The probe concentrator of claim 11, wherein the processing module further comprises a payload extraction module for extracting data from an application communication received at the local wireless network interface module.

21. The probe concentrator of claim 11, wherein the processing module further comprises a payload extraction module for extracting data from a remote server communication received at the network interface module.

22. A remote probe for testing a locally sited wireless handset with a remote server via a geographically remote network, having a communication link with the locally sited wireless handset, comprising:
a network interface module including
a network receiving module for receiving an application communication from a communication link with the locally sited wireless handset, and
a network transmitting module for sending a remote server communication to the communication link with the locally sited wireless handset;
a remote network interface module for sending the application communication via a wireless communication link to a remote server, and receiving the remote server communication via a wireless communication link from the remote server; and
a processing module for reformatting the application communication for sending by the remote network interface module, and reformatting the remote server communication for sending by the network interface module.

23. The remote probe of claim 22, wherein the remote wireless network interface module includes a wireless cellular phone network interface.

24. The remote probe of claim 22, wherein the network interface module is configured to send and receive IP based messages.

25. The remote probe of claim 22, wherein the processing module is configured to reformat SMS messages for sending by the local wireless network interface module.

26. A handset simulator for testing an application with a remote server via a geographically remote network, using a remote probe having a wireless communication link with the remote network, comprising:
an application processor simulation module for hosting an application, the application generating an application communication;
a network interface module including
a network transmitting module for sending the application communication to a remote probe, and
a network receiving module for receiving a remote server communication from the remote probe; and
a processing module including
a network formatting module for reformatting the application communication for sending by the network interface module, and reformatting the remote server communication for the application hosted by the application processor simulation module.

27. The handset simulator of claim 26, wherein the network interface module is configured to send and receive IP based messages.

28. The handset simulator of claim 26, wherein the processing module is configured to reformat SMS messages for the application hosted by the application processor simulation module.

29. The handset simulator of claim 26, further comprising a data capture module for capturing data for testing.

30. The handset simulator of claim 26, further comprising a data analysis module for performing data analysis tasks for testing.

31. The handset simulator of claim 26, further comprising a control module configured to operate in conjunction with an OAM&P server for initiating and maintaining a communication connection with the remote probe.

32. The handset simulator of claim 26, wherein the processing module further comprises a payload extraction module for extracting data from an application communication generated by the application hosted by the application processor simulation module.

33. The handset simulator of claim 26, wherein the processing module further comprises a payload extraction module for extracting data from a remote server communication received at the network interface module.

34. A method for testing an application with a remote server via a geographically remote network, the application generating an application communication, the method using a remote probe having a wireless communication link with the remote network, the method comprising:
transmitting an application communication onto a first network;
a remote probe receiving the application communication on the first network;
the remote probe reformatting the application communication for a remote network geographically remote from the originating application;
the remote probe transmitting the application communication onto the remote network;
the remote probe receiving a remote server communication on the remote network;
the remote probe reformatting the remote server communication for the first network;
the remote probe transmitting the remote server communication onto the first network;
receiving the server communication on the first network;
reformatting the server communication for the application.

35. The method of claim 34, wherein the remote network includes a wireless cellular phone network.

36. The method of claim 34, wherein the first network includes an IP based network.

37. The method of claim 34, further comprising the remote probe receiving a SMS message on a voice channel of the remote network.

38. The method of claim 34, further comprising receiving user commands through a user interface.

39. The method of claim 38, wherein the commands are for data analysis tasks.

40. The method of claim 38, wherein the commands are for data storage or retrieval tasks.

41. The method of claim 34, further comprising using an OAM&P server to initiate and maintain a communication connection on the first network with a remote probe.

42. A terminal for testing an application with a remote server via a geographically remote network, using a remote probe having a wireless communication link with the remote network, comprising:
an application module for hosting an application, the application generating an application communication;
an intended network interface module for communicating on an intended network;
an other network interface module for transmitting the application communication onto an other network to a remote probe, and receiving a remote server communication via the other network from the remote probe;
a packet distribution module for packetizing the application communication for transmission onto the intended network at the intended network interface module, and de-packetizing a remote server communication received via the intended network at the intended network interface module;
an IP module for formatting the application communication, and de-formatting the remote server communication received via the other network, and de-formatting the remote server communication received via the intended network and de-packetized at the packet distribution module; and
a switching module for binding the IP module to the intended network interface module when not testing, and binding the IP module to the other network interface module when testing.

43. The terminal of claim 42, wherein the network interface module is configured to send and receive IP based messages.

44. The terminal of claim 42, wherein the switching module is configured to reformat for the application hosted by the application module a remote server communication received via the other network and intended for a voice channel of the intended network.

45. The terminal of claim 44, wherein the remote server communication received via the other network and intended for a voice channel of the intended network is a SMS message.

46. The terminal of claim 42, wherein the other network interface module is configured for a wired network interface.

47. The terminal of claim 46, wherein the wired network interface is coupled to a USB port.

48. The terminal of claim 46, wherein the wired network interface is coupled to an Ethernet port.

49. The terminal of claim 42, wherein the other network interface module is configured as a wireless network interface.

50. The terminal of claim 47, wherein the wireless network interface is a Wi-Fi network interface.
